(19) United States
(12) Patent Application Publication
(10) Pub. No.: US 2026/0130372 A1
(43) Pub. Date: May 14, 2026

(54) FUNGICIDAL MIXTURE COMPRISING STREPTIMIDONE AND MALONOMICIN

(71) Applicant: SYNGENTA CROP PROTECTION AG, Basel (CH)

(72) Inventors: Stephane BIERI, Stein (CH); Dianne IRWIN, Bracknell, Berkshire (GB); Leon COULIER, Echt (NL)

(73) Assignee: SYNGENTA CROP PROTECTION AG, Basel (CH)

(21) Appl. No.: 19/118,625

(22) PCT Filed: Oct. 5, 2023
(86) PCT No.: PCT/EP2023/077627

§ 371 Date: Apr. 4, 2025

(30) Foreign Application Priority Data
Oct. 7, 2022 (EP) 22200224.8
Oct. 7, 2022 (EP) 22200225.5

(51) Int. Cl. A01N 43/40; A01N 25/02; A01N 43/36; A01P 3/00

(52) U.S. Cl. CPC A01N 43/40; A01N 25/02; A01N 43/36; A01P 3/00

(57) ABSTRACT

A composition comprising streptimidone and malonomicin, an agrochemical composition comprising this mixture and methods and uses of the compositions in controlling or preventing infestation of plants or other substrates by fungi.

The present invention relates to a mixture comprising two known compounds streptimidone and malonomicin, and to their use to control fungi, particularly in agriculture or horticulture. The invention also relates to fungicidal compositions, particularly agrochemical fungicidal compositions which comprise the mixture, to processes of preparation of the compositions.

Streptimidone is a known compound of formula (I)

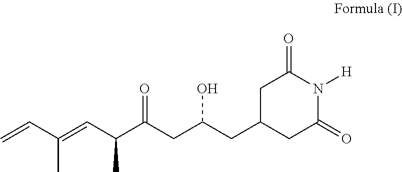 [SMILES: C=C/C(C)=C/[C@H](C)C(=O)C[C@H](O)CC1CC(=O)NC(=O)C1]

Streptimidone is described in Kondo, H., Oritani, T., and Kiyota, H. Synthesis and antifungal activity of the four stereoisomers of streptimidone, a glutarimide antibiotic from Streptomyces rimosus forma paromomycinus. Eur. J. Org. Chem. (20), 3459-3462 (2000). Many streptomyces strains express streptimidone. Streptimidone is also commercially available.

Malonomicin (sometimes spelt ‘malonomycin’) is {[(2S)-2-amino-3-hydroxypropanoyl]amino}{2-[(5S)-5-(aminomethyl)-4-hydroxy-2-oxo-2,5-dihydro-1H-pyrrol-3-yl]-2-oxoethyl}malonic acid, of formula (II)

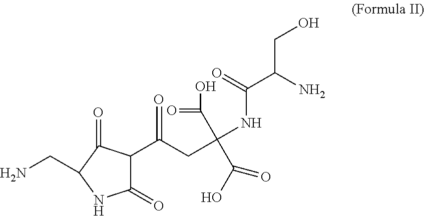 [SMILES: NCC1NC(=O)C(C(=O)CC(NC(=O)C(N)CO)(C(=O)O)C(=O)O)C1=O]

Malonomicin is a natural compound prepared by fermentation methods. U.S. Pat. No. 3,536,811 discloses malonomicin used as antibiotics and inhibitors of protozoan growth. EP1860939 describes malonomicin as an agricultural fungicide.

It has now been found that, surprisingly, a mixture comprising streptimidone and malonomicin can exhibit an unexpected synergistic fungicidal effect.

According to a first aspect of the present invention there is provided a mixture comprising streptimidone and malonomicin.

According to a second aspect of the invention, there is provided an agrochemical composition comprising a fungicidally effective amount of a mixture comprising streptimidone and malonomicin. Such an agrochemical composition may further comprise an agrochemically-acceptable diluent or carrier.

The wording agrochemical composition herein includes a chemical composition and a biological composition, preferably a non-native biological composition, for instance a biologically produced composition, for instance a microbiologically produced composition or a non-native composition.

A composition according to the present is an isolated composition. An isolated composition is refers to a non-native composition.

According to a third aspect of the invention there is provided a method of controlling or preventing infestation of plants by fungi, wherein a fungicidally effective amount of an agrochemical composition comprising a mixture comprising streptimidone and malonomicin is applied to the plants, to parts thereof or the locus thereof.

According to a fourth aspect of the invention, there is provided the use of a mixture comprising streptimidone and malonomicin as a fungicide. According to this particular aspect of the invention, the use may exclude methods for the treatment of the human or animal body by surgery or therapy.

Many Streptomyces strains express streptimidone. Streptimidone is also commercially available.

Malonomicin may be prepared according to the method disclosed in Examples I A and B in EP 1860939. or according to Law et al, 2018 (Nature Catalysis|VOL 1|DECEMBER 2018 f 977-984).

The mixture comprising streptimidone and malonomicin can be used in the agricultural sector and related fields of use, e.g., as active ingredient for controlling fungal plant pests or on non-living materials for the control of spoilage fungi or fungi potentially harmful to humans. A mixture comprising streptimidone and malonomicin has surprising activity at low rates of application and is well tolerated by plants. It has very useful curative and preventive properties and can be used for protecting a wide range of cultivated plants. The mixture comprising streptimidone and malonomicin additionally has a surprising synergistic effect. And can be used to inhibit or destroy the fungi that occur on plants or parts of plants (fruit, blossoms, leaves, stems, tubers, roots) of different crops of useful plants, while at the same time protecting also those parts of the plants that grow later.

The present invention further relates to a method for controlling or preventing infestation of plants or plant propagation material and/or harvested food crops susceptible to fungal attack by treating plants or plant propagation material and/or harvested food crops wherein a fungicidally effective amount of a mixture comprising streptimidone and malonomicin is applied to the plants, to parts thereof or the locus thereof.

It is also possible to use the mixture comprising streptimidone and malonomicin more broadly as a fungicide. The term “fungicide” as used herein means a compound that controls, modifies, or prevents the growth of fungi. The term “fungicidally effective amount” where used means the quantity of such a compound or combination of such compounds that is capable of producing an effect on the growth of fungi. Controlling or modifying effects include all deviation from natural development, such as killing, retardation and the like, and prevention includes barrier or other defensive formation in or on a plant to prevent fungal infection.

It may also be possible to use a mixture comprising streptimidone and malonomicin as dressing agents for the treatment of plant propagation material, e.g., seed, such as fruits, tubers or grains, or plant cuttings, for the protection against fungal infections as well as against phytopathogenic fungi occurring in the soil. The propagation material can be treated with a composition comprising streptimidone and malonomicin before planting: seed, for example, can be dressed before being sown. Streptimidone and malonomicin can also be applied to grains (coating), either by impregnating the seeds in a liquid formulation or by coating them with a solid formulation. The composition can also be applied to the planting site when the propagation material is being planted, for example, to the seed furrow during sowing. The invention relates also to such methods of treating plant propagation material and to the plant propagation material so treated.

Furthermore, a mixture comprising streptimidone and malonomicin can be used for controlling fungi in related areas, for example in the protection of technical materials, including wood and wood related technical products, in food preservation, in pharmaceutical applications, in veterinary applications and in hygiene management.

In addition, the invention could be used to protect non-living materials from fungal attack, e.g. lumber, wall boards, wallpaper and paint.

Examples of important fungi that require control in agriculture and other areas are:
Botrytis cinerea, Cercospora kikuchii, Cercospora sojina, Cochliobolus sativus, Colletotrichum lindemuthianum, Colletotrichum orbiculare, Corynespora cassiicola, Fusarium avenaceum, Fusarium culmorum, Fusarium langsethiae, Fusarium poae, Fusarium sporotrichioides, Fusarium tricinctum, Fusarium virguliforme, Gibberella avenacea, Gibberella fujikuroi, Gibberella zeae, Microdochium majus, Monographella nivalis, Mycosphaerella arachidis, Phakopsora pachyrhizi, Puccinia triticina (=P. recondita), Pyrenophora tritici-repentis, Ramularia collo-cygni, Rhynchosporium secalis, Septoria glycines, Tilletia tritici, Ustilago segetum var. Tritici, Venturia inaequalis, and Zymoseptoria tritici.

Preferred examples of fungi are Gibberella species including Gibberella zeae (also known as Fusarium graminearum), Fusarium species including Fusarium virguliforme (also known as Fusarium solani f. sp. glycines or sudden death syndrome of soybean) Microdochium species such as Monographella nivalis (also known as Microdichium nivale or Cereal Head Blight) and Zymoseptoria or Mycosphaerella species such as Zymoseptoria tritici (also known as Septoria tritici, Mycosphaerella graminicola or Septoria Leaf Blotch), especially, Zymoseptoria tritici, Microdichium nivale (=Monographella nivalis) and Gibberella zeae (=Fusarium graminearum).

Particularly preferred are Fusarium avenaceum, Fusarium culmorum, Fusarium langsethiae, Fusarium poae, Fusarium sporotrichioides, Fusarium tricinctum, Fusarium virguliforme, Fusarium verticillioides, Fusarium subglutinans Zymoseptoria tritici, Puccinia triticina (=P. recondita), Mycosphaerella fijiensis, Puccinia striiformis, Magnaporthe grisea and Rhizoctonia solani.

Target crops and/or useful plants to be protected typically comprise perennial and annual crops, such as berry plants for example blackberries, blueberries, cranberries, raspberries and strawberries; cereals for example barley, maize (corn), millet, oats, rice, rye, sorghum, triticale and wheat; fibre plants for example cotton, flax, hemp, jute and sisal; field crops for example sugar and fodder beet, coffee, hops, mustard, oilseed rape (canola), poppy, sugar cane, sunflower, tea and tobacco; fruit trees for example apple, apricot, avocado, banana, cherry, citrus, nectarine, peach, pear and plum; grasses for example Bermuda grass, bluegrass, bentgrass, centipede grass, fescue, ryegrass, St. Augustine grass and Zoysia grass; herbs such as basil, borage, chives, coriander, lavender, lovage, mint, oregano, parsley, rosemary, sage and thyme; legumes for example beans, lentils, peas and soya beans; nuts for example almond, cashew, ground nut, hazelnut, peanut, pecan, pistachio and walnut; palms for example oil palm; ornamentals for example flowers, shrubs and trees; other trees, for example cacao, coconut, olive and rubber; vegetables for example asparagus, aubergine, broccoli, cabbage, carrot, cucumber, garlic, lettuce, marrow, melon, okra, onion, pepper, potato, pumpkin, rhubarb, spinach and tomato; and vines for example grapes.

The terms “crops” or “useful plants” is to be understood as also including useful plants that have been rendered tolerant to herbicides like bromoxynil or classes of herbicides (such as, for example, HPPD inhibitors, ALS inhibitors, for example primisulfuron, prosulfuron and trifloxysulfuron, EPSPS (5-enol-pyrovyl-shikimate-3-phosphate-synthase) inhibitors, GS (glutamine synthetase) inhibitors or PPO (protoporphyrinogen-oxidase) inhibitors) as a result of conventional methods of breeding or genetic engineering. An example of a crop that has been rendered tolerant to imidazolinones, e.g. imazamox, by conventional methods of breeding (mutagenesis) is Clearfield® summer rape (Canola). Examples of crops that have been rendered tolerant to herbicides or classes of herbicides by genetic engineering methods include glyphosate- and glufosinate-resistant maize varieties commercially available under the trade names RoundupReady®, Herculex I® and LibertyLink®.

The terms “crops” or “useful plants” is to be understood as also including useful plants which have been so transformed by the use of recombinant DNA techniques that they are capable of synthesising one or more selectively acting toxins, such as are known, for example, from toxin-producing bacteria, especially those of the genus Bacillus.

A mixture comprising streptimidone and malonomicin may also be used for example on turf, ornamentals, such as flowers, shrubs, broad-leaved trees or evergreens, for example conifers, as well as for tree injection, pest management and the like.

Preferred crops on which a mixture comprising streptomidone and malonomicin can be used include banana, cereals and pulses, such as ground nut or soybean and cereals such as wheat, barley, rice or maize.

The term “locus” as used herein means fields in or on which plants are growing, or where seeds of cultivated plants are sown, or where seed will be placed into the soil. It includes soil, seeds, and seedlings, as well as established vegetation.

The term “plants” refers to all physical parts of a plant, including seeds, seedlings, saplings, roots, tubers, stems, stalks, foliage, and fruits.

The term “plant propagation material” is understood to denote generative parts of the plant, such as seeds, which can be used for the multiplication of the latter, and vegetative material, such as cuttings or tubers, for example potatoes. There can be mentioned for example seeds (in the strict sense), roots, fruits, tubers, bulbs, rhizomes and parts of plants. Germinated plants and young plants which are to be transplanted after germination or after emergence from the soil, may also be mentioned. These young plants can be protected before transplantation by a total or partial treatment by immersion. Preferably “plant propagation material” is understood to denote seeds.

The mixture comprising streptimidone and malonomicin may be used in unmodified form or, preferably, together with the adjuvants conventionally employed in the art of formulation. To this end it may be conveniently formulated in known manner to emulsifiable concentrates, coatable pastes, directly sprayable or dilutable solutions or suspensions, dilute emulsions, wettable powders, soluble powders, dusts, granulates, and also encapsulations e.g. in polymeric substances. As with the type of the compositions, the methods of application, such as spraying, atomising, dusting, scattering, coating or pouring, are chosen in accordance with the intended objectives and the prevailing circumstances. The compositions may also contain further adjuvants such as stabilizers, antifoams, viscosity regulators, binders or tackifiers as well as fertilizers, micronutrient donors or other formulations for obtaining special effects.

When streptimidone is produced by a microorganism, it may be isolated from that microorganism. Alternatively, there may be significant quantities of streptimidone in the culture medium in which the microorganism is grown in which case a fungicidal composition can be formulated using the culture medium, or broth together with malonomicin. As a further alternative, the microorganism may produce both Streptimidone and malonomicin in which case the microorganism itself can be used to formulate a composition. Hence, there is disclosed a process for producing streptimidone and malonomicin comprising fermenting a microorganism in a suitable fermentation medium under conditions that allow the production of streptimidone and malonomicin. In such cases the microorganism can be formulated as living cells actively producing streptimidone and malonomicin or it can be inactivated, for example by heat treatment. The microorganism can be concentrated if necessary, by centrifuge or other conventional techniques.

Suitable carriers and adjuvants, e.g. for agricultural use, can be solid or liquid and are substances useful in formulation technology, e.g. natural or regenerated mineral substances, solvents, dispersants, wetting agents, tackifiers, thickeners, binders or fertilizers. Such carriers are for example described in WO 97/33890.

Suspension concentrates are formulations in which finely divided solid particles of the active compound are suspended in a liquid. Such formulations include anti-settling agents and dispersing agents and may further include a wetting agent to enhance activity as well as an anti-foam and a crystal growth inhibitor. In use, these concentrates are diluted in water and normally applied as a spray to the area to be treated. The amount of active ingredient may range from 0.5% to 95% of the concentrate.

Wettable powders are in the form of finely divided particles which disperse readily in water or other liquid carriers. The particles contain the active ingredient retained in a solid matrix. Typical solid matrices include fuller's earth, kaolin clays, silicas and other readily wet organic or inorganic solids. Wettable powders normally contain from 5% to 95% of the active ingredient plus a small amount of wetting, dispersing or emulsifying agent.

Emulsifiable concentrates are homogeneous liquid compositions dispersible in water or other liquid and may consist entirely of the active compound with a liquid or solid emulsifying agent, or may also contain a liquid carrier, such as xylene, heavy aromatic naphthas, isophorone and other non-volatile organic solvents. In use, these concentrates are dispersed in water or other liquid and normally applied as a spray to the area to be treated. The amount of active ingredient may range from 0.5% to 95% of the concentrate.

Granular formulations include both extrudates and relatively coarse particles and are usually applied without dilution to the area in which treatment is required. Typical carriers for granular formulations include sand, fuller's earth, attapulgite clay, bentonite clays, montmorillonite clay, vermiculite, perlite, calcium carbonate, brick, pumice, pyrophyllite, kaolin, dolomite, plaster, wood flour, ground corn cobs, ground peanut hulls, sugars, sodium chloride, sodium sulphate, sodium silicate, sodium borate, magnesia, mica, iron oxide, zinc oxide, titanium oxide, antimony oxide, cryolite, gypsum, diatomaceous earth, calcium sulphate and other organic or inorganic materials which absorb or which can be coated with the active compound. Granular formulations normally contain 5% to 25% of active ingredients which may include surface-active agents such as heavy aromatic naphthas, kerosene and other petroleum fractions, or vegetable oils; and/or stickers such as dextrins, glue or synthetic resins.

Dusts are free-flowing admixtures of the active ingredient with finely divided solids such as talc, clays, flours and other organic and inorganic solids which act as dispersants and carriers.

Microcapsules are typically droplets or granules of the active ingredient enclosed in an inert porous shell which allows escape of the enclosed material to the surroundings at controlled rates. Encapsulated droplets are typically 1 to 50 microns in diameter. The enclosed liquid typically constitutes 50 to 95% of the weight of the capsule and may include solvent in addition to the active compound. Encapsulated granules are generally porous granules with porous membranes sealing the granule pore openings, retaining the active species in liquid form inside the granule pores. Granules typically range from 1 millimetre to 1 centimetre and preferably 1 to 2 millimetres in diameter. Granules are formed by extrusion, agglomeration or prilling, or are naturally occurring. Examples of such materials are vermiculite, sintered clay, kaolin, attapulgite clay, sawdust and granular carbon. Shell or membrane materials include natural and synthetic rubbers, cellulosic materials, styrene-butadiene copolymers, polyacrylonitriles, polyacrylates, polyesters, polyamides, polyureas, polyurethanes and starch xanthates.

Other useful formulations for agrochemical applications include simple solutions of the active ingredient in a solvent in which it is completely soluble at the desired concentration, such as water, acetone, alkylated naphthalenes, xylene and other organic solvents. Pressurised sprayers, wherein the active ingredient is dispersed in finely-divided form as a result of vaporisation of a low boiling dispersant solvent carrier, may also be used.

Suitable agricultural adjuvants and carriers that are useful in formulating the compositions of the invention in the formulation types described above are well known to those skilled in the art.

Liquid carriers that can be employed include, for example, water, vegetable oils, toluene, xylene, petroleum naphtha, crop oil, acetone, methyl ethyl ketone, cyclohexanone, acetic anhydride, acetonitrile, acetophenone, amyl acetate, 2-butanone, chlorobenzene, cyclohexane, cyclohexanol, alkyl acetates, diacetonalcohol, 1,2-dichloropropane, diethanolamine, p-diethylbenzene, diethylene glycol, diethylene glycol abietate, diethylene glycol butyl ether, diethylene glycol ethyl ether, diethylene glycol methyl ether, N,N-dimethyl formamide, dimethyl sulfoxide, 1,4-dioxane, dipropylene glycol, dipropylene glycol methyl ether, dipropylene glycol dibenzoate, diproxitol, alkyl pyrrolidinone, ethyl acetate, 2-ethyl hexanol, ethylene carbonate, 1,1,1-trichloroethane, 2-heptanone, alpha pinene, d-limonene, ethylene glycol, ethylene glycol butyl ether, ethylene glycol methyl ether, gamma-butyrolactone, glycerol, glycerol diacetate, glycerol monoacetate, glycerol triacetate, hexadecane, hexylene glycol, isoamyl acetate, isobornyl acetate, isooctane, isophorone, isopropyl benzene, isopropyl myristate, lactic acid, laurylamine, mesityl oxide, methoxy-propanol, methyl isoamyl ketone, methyl isobutyl ketone, methyl laurate, methyl octanoate, methyl oleate, methylene chloride, m-xylene, n-hexane, n-octylamine, octadecanoic acid, octyl amine acetate, oleic acid, oleylamine, o-xylene, phenol, polyethylene glycol (PEG400), propionic acid, propylene glycol, propylene glycol monomethyl ether, p-xylene, toluene, triethyl phosphate, triethylene glycol, xylene sulfonic acid, paraffin, mineral oil, trichloroethylene, perchloroethylene, ethyl acetate, amyl acetate, butyl acetate, methanol, ethanol, isopropanol, and higher molecular weight alcohols such as amyl alcohol, tetrahydrofurfuryl alcohol, hexanol, octanol, etc., ethylene glycol, propylene glycol, glycerine and N-methyl-2-pyrrolidinone. Water is generally the carrier of choice for the dilution of concentrates.

Suitable solid carriers include, for example, talc, titanium dioxide, pyrophyllite clay, silica, attapulgite clay, kieselguhr, chalk, diatomaxeous earth, lime, calcium carbonate, bentonite clay, fuller's earth, cotton seed hulls, wheat flour, soybean flour, pumice, wood flour, walnut shell flour and lignin.

A broad range of surface-active agents are advantageously employed in both said liquid and solid compositions, especially those designed to be diluted with carrier before application. These agents, when used, normally comprise from 0.01% to 15% by weight of the formulation. They can be anionic, cationic, non-ionic or polymeric in character and can be employed as emulsifying agents, wetting agents, suspending agents or for other purposes. Typical surface-active agents include Tween 20, salts of alkyl sulfates, such as diethanolammonium lauryl sulphate; alkylarylsulfonate salts, such as calcium dodecylbenzenesulfonate; alkylphenol-alkylene oxide addition products, such as nonylphenol-C.sub. 18 ethoxylate; alcohol-alkylene oxide addition products, such as tridecyl alcohol-C.sub. 16 ethoxylate; soaps, such as sodium stearate; alkylnaphthalenesulfonate salts, such as sodium dibutylnaphthalenesulfonate; dialkyl esters of sulfosuccinate salts, such as sodium di(2ethylhexyl) sulfosuccinate; sorbitol esters, such as sorbitol oleate; quaternary amines, such as lauryl trimethylammonium chloride; polyethylene glycol esters of fatty acids, such as polyethylene glycol stearate; block copolymers of ethylene oxide and propylene oxide; and salts of mono and dialkyl phosphate esters.

Other adjuvants commonly utilized in agricultural compositions include crystallisation inhibitors, viscosity modifiers, suspending agents, spray droplet modifiers, pigments, antioxidants, foaming agents, anti-foaming agents, light-blocking agents, compatibilizing agents, antifoam agents, sequestering agents, neutralising agents and buffers, corrosion inhibitors, dyes, odorants, spreading agents, penetration aids, micronutrients, emollients, lubricants and sticking agents.

In addition, further, other agrochemically active ingredients or compositions may be combined with the compositions of the invention and used in the methods of the invention and applied simultaneously or sequentially with the compositions of the invention. When applied sequentially, the compositions of the invention may be applied to a plant during a different growth phase than other agrochemically active ingredients. When applied simultaneously, these further active ingredients may be formulated together with the compositions of the invention or mixed in, for example, the spray tank. These further agrochemically active ingredients may be fungicides, herbicides, insecticides, bactericides, acaricides, nematicides growth stimulants and/or plant growth regulators.

Pesticidal agents are referred to herein using their common name are known, for example, from “The Pesticide Manual”, 19th Ed., British Crop Protection Council 2021.

The mixture according to the invention can be mixed with one or more insecticides known in the art.

The mixture according to the invention can be mixed with one or more fungicides, including biological fungicides, known in the art.

The mixture comprising streptimidone and malonomicin can be used in the form of an agrochemical composition and can be applied to the crop area or plant to be treated, simultaneously or in succession with further compounds. These further compounds can be e.g. fertilizers or micronutrient donors or other preparations, which influence the growth of plants. They can also be selective herbicides or non-selective herbicides as well as insecticides, fungicides, bactericides, nematicides, molluscicides or mixtures of several of these preparations, if desired together with further carriers, surfactants or application promoting adjuvants customarily employed in the art of formulation.

The mixture comprising streptimidone and malonomicin may be used in the form of (fungicidal) compositions for controlling or protecting against phytopathogenic microorganisms, comprising as active ingredients streptimidone and malonomicin and at least one of the above-mentioned adjuvants.

The invention therefore provides a composition, preferably a fungicidal composition, comprising streptimidone, malonomicin, an agriculturally acceptable carrier and optionally an adjuvant. An agricultural acceptable carrier is for example a carrier that is suitable for agricultural use. Agricultural carriers are well known in the art. Preferably said composition may comprise at least one or more pesticidally-active compounds, for example an additional fungicidal active ingredient in addition to streptimidone and malonomicin.

The compositions according to the invention can also comprise further solid or liquid auxiliaries, such as stabilizers, for example unepoxidized or epoxidized vegetable oils (for example epoxidized coconut oil, rapeseed oil or soya oil), antifoams, for example silicone oil, preservatives, viscosity regulators, binders and/or tackifiers, fertilizers or other active ingredients for achieving specific effects, for example bactericides, fungicides, nematocides, plant activators, molluscicides or herbicides.

The compositions according to the invention are prepared in a manner known per se, in the absence of auxiliaries for example by grinding, screening and/or compressing a solid active ingredient and in the presence of at least one auxiliary for example by intimately mixing and/or grinding the active ingredient with the auxiliary (auxiliaries). These processes for the preparation of the compositions and the use of the compounds (1) for the preparation of these compositions are also a subject of the invention.

Another aspect of the invention is related to the use of a composition comprising streptimidone and malonomicin, or of a fungicidal or insecticidal mixture comprising streptimidone and malonomicin, in admixture with other fungicides or insecticides as described above, for controlling or preventing infestation of plants, e.g. useful plants such as crop plants, propagation material thereof, e.g. seeds, harvested crops, e.g. harvested food crops, or non-living materials by insects or by phytopathogenic microorganisms, preferably fungal organisms.

A further aspect of the invention is related to a method of controlling or preventing an infestation of plants, e.g., useful plants such as crop plants, propagation material thereof, e.g. seeds, harvested crops, e.g., harvested food crops, or of non-living materials by insects or by phytopathogenic or spoilage microorganisms or organisms potentially harmful to man, especially fungal organisms, which comprises the application of a mixture comprising streptimidone and malonomicin as active ingredients to the plants, to parts of the plants or to the locus thereof, to the propagation material thereof, or to any part of the non-living materials.

Controlling or preventing means reducing infestation by phytopathogenic or spoilage microorganisms or organisms potentially harmful to man, especially fungal organisms, to such a level that an improvement is demonstrated.

A preferred method of controlling or preventing an infestation of crop plants by phytopathogenic microorganisms, especially fungal organisms, or insects which comprises the application of a compound of Formula (I) and a compound of Formula (II), or an agrochemical composition which contains at least one of said compounds, is foliar application. The frequency of application and the rate of application will depend on the risk of infestation by the corresponding pathogen. However, the compositions of the invention can also penetrate the plant through the roots via the soil by drenching the locus of the plant with a liquid formulation, or by applying the compounds in solid form to the soil, e.g. in granular form (soil application). In crops of water rice such granulates can be applied to the flooded rice field. The mixtures of the invention may also be applied to seeds (coating) by impregnating the seeds or tubers either with a liquid formulation of the fungicide or coating them with a solid formulation.

A formulation, e.g. a composition containing the mixture of the invention, and, if desired, a solid or liquid adjuvant or monomers for encapsulating the mixture of the invention, may be prepared in a known manner, typically by intimately mixing and/or grinding the compound with extenders, for example solvents, solid carriers and, optionally, surface active compounds (surfactants).

The weight/molar ratio of the streptimidone to the malonomicin is preferably 10:1 to 1:500, more preferably 1:1 to 1:300, most preferably 1:10 to 1:100.

Preferred rates of application are normally from 0.1 g to 6 kg of active ingredients (a.i.; the combined weight of streptimidone and malonomicin) per hectare (ha), preferably from 0.1 g to 1 kg a.i./ha, most preferably from 10 g to 800 g a.i./ha.

When the combinations of the present invention are used for treating seed, rates of 0.001 to 100 g of active ingredients per kg of seed, preferably from 0.01 to 10 g per kg of seed are generally sufficient.

Suitably, a composition comprising streptimidone and malonomicin according to the present invention is applied either preventative, meaning prior to disease development or curative, meaning after disease development.

Certain mixtures of streptimidone and malonomicin may show a synergistic effect. This occurs whenever the action of an active ingredient combination is greater than the sum of the actions of the individual components. The action to be expected E for a given active ingredient combination obeys the so-called COLBY formula and can be calculated as follows (COLBY, S. R. “Calculating synergistic and antagonistic responses of herbicide combination”. Weeds, Vol. 15, pages 20-22; 1967):
ppm=milligrams of active ingredient (=a.i.) per liter of spray mixture
X=% action by active ingredient A) using p ppm of active ingredient
Y=% action by active ingredient B) using q ppm of active ingredient.

According to COLBY, the expected (additive) action of active ingredients A)+B) using p+q ppm of active ingredient is:

$$E = X + Y - \frac{X \cdot y}{100} .$$

If the action actually observed (O) is greater than the expected action (E), then the action of the combination is super-additive, i.e. there is a synergistic effect. In mathematical terms, synergism corresponds to a positive value for the difference of (O-E). In the case of purely complementary addition of activities (expected activity), said difference (O-E) is zero. A negative value of said difference (O-E) signals a loss of activity compared to the expected activity.

However, besides the actual synergistic action with respect to fungicidal activity, the composition according to the invention may also have further surprising advantageous properties. Examples of such advantageous properties that may be mentioned are: more advantageous degradability; improved toxicological and/or ecotoxicological behaviour; or improved characteristics of the useful plants including: emergence, crop yields, more developed root system, tillering increase, increase in plant height, bigger leaf blade, less dead basal leaves, stronger tillers, greener leaf colour, less fertilizers needed, less seeds needed, more productive tillers, earlier flowering, early grain maturity, less plant verse (lodging), increased shoot growth, improved plant vigor, and early germination.

The compositions of the invention may be employed in any conventional form, for example in the form of a twin pack, a powder for dry seed treatment (DS), an emulsion for seed treatment (ES), a flowable concentrate for seed treatment (FS), a solution for seed treatment (LS), a water dispersible powder for seed treatment (WS), a capsule suspension for seed treatment (CF), a gel for seed treatment (GF), an emulsion concentrate (EC), a suspension concentrate (SC), a suspo-emulsion (SE), a capsule suspension (CS), a water dispersible granule (WG), an emulsifiable granule (EG), an emulsion, water in oil (EO), an emulsion, oil in water (EW), a micro-emulsion (ME), an oil dispersion (OD), an oil miscible flowable (OF), an oil miscible liquid (OL), a soluble concentrate (SL), an ultra-low volume suspension (SU), an ultra-low volume liquid (UL), a technical concentrate (TK), a dispersible concentrate (DC), a wettable powder (WP) or any technically feasible formulation in combination with agriculturally acceptable adjuvants.

Such compositions may be produced in conventional manner, e.g. by mixing the active ingredients with appropriate formulation inerts (diluents, solvents, fillers and optionally other formulating ingredients such as surfactants, biocides, anti-freeze, stickers, thickeners and compounds that provide adjuvancy effects). Also conventional slow release formulations may be employed where long lasting efficacy is intended. Particularly formulations to be applied in spraying forms, such as water dispersible concentrates (e.g. EC, SC, DC, OD, SE, EW, EO and the like), wettable powders and granules, may contain surfactants such as wetting and dispersing agents and other compounds that provide adjuvancy effects, e.g. the condensation product of formaldehyde with naphthalene sulphonate, an alkylarylsulphonate, a lignin sulphonate, a fatty alkyl sulphate, and ethoxylated alkylphenol and an ethoxylated fatty alcohol.

A seed dressing formulation is applied in a manner known per se to the seeds employing the combination of the invention and a diluent in suitable seed dressing formulation form, e.g. as an aqueous suspension or in a dry powder form having good adherence to the seeds. Such seed dressing formulations are known in the art. Seed dressing formulations may contain the single active ingredients or the combination of active ingredients in encapsulated form, e.g. as slow release capsules or microcapsules.

In general, the formulations include from 0.01 to 90% by weight of active agent, from 0 to 20% agriculturally acceptable surfactant and 10 to 99.99% solid or liquid formulation inerts and adjuvant(s), streptimidone, malonomicin optionally together with other active agents, particularly microbiocides or conservatives or the like. Concentrated forms of compositions generally contain in between about 2 and 80%, preferably between about 5 and 70% by weight of active agent. Application forms of formulation may for example contain from 0.01 to 20% by weight, preferably from 0.01 to 5% by weight of active agent. Whereas commercial products will preferably be formulated as concentrates, the end user will normally employ diluted formulations.

### EXAMPLES

The Examples which follow serve to illustrate the invention. Temperatures are given in degrees Celsius (° C.) and rh means relative humidity and ppm means parts per million by weight. Colby is a reference to COLBY, S. R. “Calculating synergistic and antagonistic responses of herbicide combination”. Weeds, Vol. 15, pages 20-22; 1967, discussed above.

### EXAMPLES

1 Fungicidal Activity of a Mixtures with Malonomicin in Liquid Culture Assays

### Method:

Streptimidone (CAS: 738-72-7) was purchased from a commercial vendor. A stock solution for streptimidone was produced in DMSO (max. 10 mg/ml). Malonomicin was produced according to Law et al, 2018 (Nature Catalys is |VOL 1|December 2018|977-984). A stock solution of malonomicin was produced in water plus 0.025% Tween20.

Assays to test efficacy of mixtures of streptimidone in combination with malonomicin on the control of fungal pathogens in a liquid culture assay were designed for a 96well plate.

Table1: outline of 96well testplate including concentration of compounds per well. The upper number in the cell indicates malonomicin concentration (ppm), the lower number streptimidone concentration (ppm). Column (1) holds a dilution series of streptimidone, row (H) holds a dilution series of malonomicin, column (12) holds cells representing untreated check.

| ppm | (1) | (2) | (3) | (4) | (5) | (6) | (7) | (8) | (9) | (10) | (11) | (12) |
|---|---|---|---|---|---|---|---|---|---|---|---|---|
| A | 0 | 1000 | 500 | 250 | 125 | 62.5 | 31.25 | 15.63 | 7.81 | 3.00 | 1.00 | 0 |
| | 100 | 100 | 100 | 100 | 100 | 100 | 100 | 100 | 100 | 100 | 100 | 0 |
| B | 0 | 1000 | 500 | 250 | 125 | 62.5 | 31.25 | 15.63 | 7.81 | 3.00 | 1.00 | 0 |
| | 50 | 50 | 50 | 50 | 50 | 50 | 50 | 50 | 50 | 50 | 50 | 0 |
| C | 0 | 1000 | 500 | 250 | 125 | 62.5 | 31.25 | 15.63 | 7.81 | 3.00 | 1.00 | 0 |
| | 25 | 25 | 25 | 25 | 25 | 25 | 25 | 25 | 25 | 25 | 25 | 0 |
| D | 0 | 1000 | 500 | 250 | 125 | 62.5 | 31.25 | 15.63 | 7.81 | 3.00 | 1.00 | 0 |
| | 12.5 | 12.5 | 12.5 | 12.5 | 12.5 | 12.5 | 12.5 | 12.5 | 12.5 | 12.5 | 12.5 | 0 |
| E | 0 | 1000 | 500 | 250 | 125 | 62.5 | 31.25 | 15.63 | 7.81 | 3.00 | 1.00 | 0 |
| | 6.25 | 6.25 | 6.25 | 6.25 | 6.25 | 6.25 | 6.25 | 6.25 | 6.25 | 6.25 | 6.25 | 0 |
| F | 0 | 1000 | 500 | 250 | 125 | 62.5 | 31.25 | 15.63 | 7.81 | 3.00 | 1.00 | 0 |
| | 3.125 | 3.125 | 3.125 | 3.125 | 3.125 | 3.125 | 3.125 | 3.125 | 3.125 | 3.125 | 3.125 | 0 |
| G | 0 | 1000 | 500 | 250 | 125 | 62.5 | 31.25 | 15.63 | 7.81 | 3.00 | 1.00 | 0 |
| | 1.56 | 1.56 | 1.56 | 1.56 | 1.56 | 1.56 | 1.56 | 1.56 | 1.56 | 1.56 | 1.56 | 0 |
| H | 0 | 1000 | 500 | 250 | 125 | 62.5 | 31.25 | 15.63 | 7.81 | 3.00 | 1.00 | 0 |
| | 0 | 0 | 0 | 0 | 0 | 0 | 0 | 0 | 0 | 0 | 0 | 0 |

The 96 well plate design allows to compare disease control of the mixture with disease control of the respective single compound at the same rate. The comparison of the assessed efficacy from a mixture with the calculated efficacy of the same mixture according to Colby allows a statement if a mixture is additive (efficacy is similar to Colby calculation), synergistic (efficacy is better than Colby calculation) or antagonistic (efficacy is inferior to Colby calculation).

The same 96 well plate design also allows to assess if the two compounds can be mixed at different use rates and mixture ratios. the plate design outlined in table 1 will provide the following mixture ratios, as shown in table 2.

Table 2: Mixture ratio of two compounds in the 96well plate assay design as outlined in table 1. The number represents the ratio of compound 1:compound 2. Compound 1 is malonomicin, and compound 2 is streptimidone. The plate design spans a wide range from 641:1 to 1:100.

| | (1) | (2) | (3) | (4) | (5) | (6) | (7) | (8) | (9) | (10) | (11) | (12) |
|---|---|---|---|---|---|---|---|---|---|---|---|---|
| A | n.a. | 10:1 | 5:1 | 2.5:1 | 1.25:1 | 1:1.6 | 1:3.2 | 1:6 | 1:13 | 1:33 | 1:100 | n.a. |
| B | n.a. | 20:1 | 10:1 | 5:1 | 2.5:1 | 1.25:1 | 1:1.6 | 1:3.2 | 1:6 | 1:17 | 1:50 | n.a. |
| C | n.a. | 40:1 | 20:1 | 10:1 | 5:1 | 2.5:1 | 1.25:1 | 1:1.6 | 1:3.2 | 1:8 | 1:25 | n.a. |
| D | n.a. | 80:1 | 40:1 | 20:1 | 10:1 | 5:1 | 2.5:1 | 1.25:1 | 1:1.6 | 1:4.2 | 1:13 | n.a. |
| E | n.a. | 160:1 | 80:1 | 40:1 | 20:1 | 10:1 | 5:1 | 2.5:1 | 1.25:1 | 1:2.1 | 1:6 | n.a. |
| F | n.a. | 320:1 | 160:1 | 80:1 | 40:1 | 20:1 | 10:1 | 5:1 | 2.5:1 | 1:1 | 1:3.1 | n.a. |
| G | n.a. | 641:1 | 321:1 | 160:1 | 80:1 | 40:1 | 20:1 | 10:1 | 5:1 | 1.9:1 | 1:1.6 | n.a. |
| H | n.a. | n.a. | n.a. | n.a. | n.a. | n.a. | n.a. | n.a. | n.a. | n.a. | n.a. | n.a. |

A master plate with 10× concentrated solution of the compound stock solutions diluted in water plus 0.025% Tween20 was prepared. The concentration of DMSO (from the stock of streptimidone) and Tween20 was kept constant in all cells of the master plate. 10 μl was transferred from the master plate to a 96well test plate. The nutrient broth containing the fungal spores/mycelia fragments was then added to the test plate to give an end concentration of 1× for the tested compounds (as outlined in table 1). The test plates were incubated in the dark at 2400 and 96% rh. The inhibition of fungal growth was determined photometrically after ca 3 days, and percent fungal growth reduction relative to the untreated check was calculated. Efficacy of the mixtures was tested on a fungal species:
Botrytis cinerea (EPPO code: BOTRCI)

Conidia of the fungus from cryogenic storage were directly mixed into nutrient broth (Vogel's minimal media). The test plates were incubated at 24° C. and the inhibition of growth was determined photometrically after 72 hrs.

### Results

Table 3: Control of Botrytis cinerea for solo compounds and mixtures. The plate design including the concentration of streptimidone and malonomicin are indicated in table 1. Values indicate control of fungal growth (% reduction of growth in the test well as compared to untreated check).

| | (1) | (2) | (3) | (4) | (5) | (6) | (7) | (8) | (9) | (10) | (11) | (12) |
|---|---|---|---|---|---|---|---|---|---|---|---|---|
| A | 0 | 70 | 70 | 70 | 70 | 70 | 50 | 50 | 20 | 20 | 0 | 0 |
| B | 0 | 70 | 70 | 70 | 70 | 70 | 50 | 20 | 20 | 0 | 0 | 0 |
| C | 0 | 70 | 70 | 70 | 70 | 70 | 50 | 20 | 0 | 0 | 0 | 0 |
| D | 0 | 70 | 70 | 70 | 70 | 70 | 50 | 20 | 0 | 0 | 0 | 0 |
| E | 0 | 70 | 70 | 70 | 70 | 70 | 50 | 20 | 0 | 0 | 0 | 0 |
| F | 0 | 70 | 70 | 70 | 70 | 70 | 50 | 20 | 0 | 0 | 0 | 0 |
| G | 0 | 70 | 70 | 70 | 70 | 70 | 50 | 20 | 0 | 0 | 0 | 0 |
| H | 0 | 70 | 70 | 70 | 70 | 70 | 50 | 0 | 0 | 0 | 0 | 0 |

Table 4: Comparison of measured values for disease control of Botrytis cinerea (as reported in table 3) with calculated values using the formula from Colby for the same mixture. Numbers reported in the table represent the difference from measured efficacy (in %) minus calculated efficacy (in ° %). Values around 0 (zero) indicate additive activity, while values of above zero suggest synergistic activity.

| | (1) | (2) | (3) | (4) | (5) | (6) | (7) | (8) | (9) | (10) | (11) | (12) |
|---|---|---|---|---|---|---|---|---|---|---|---|---|
| A | | 0 | 0 | 0 | 0 | 0 | 0 | 50 | 20 | 20 | 0 | |
| B | | 0 | 0 | 0 | 0 | 0 | 0 | 20 | 20 | 0 | 0 | |
| C | | 0 | 0 | 0 | 0 | 0 | 0 | 20 | 0 | 0 | 0 | |
| D | | 0 | 0 | 0 | 0 | 0 | 0 | 20 | 0 | 0 | 0 | |
| E | | 0 | 0 | 0 | 0 | 0 | 0 | 20 | 0 | 0 | 0 | |
| F | | 0 | 0 | 0 | 0 | 0 | 0 | 20 | 0 | 0 | 0 | |
| G | | 0 | 0 | 0 | 0 | 0 | 0 | 20 | 0 | 0 | 0 | |
| H | | | | | | | | | | | | |

### Conclusions:

Streptimidone and malonomicin can be mixed to obtain full or partial control of fungal pathogens. The mixture ratio of the two compounds can vary greatly in mixtures and still produce 50% or more control of the fungal growth. Surprisingly, the efficacy of many mixtures is better than the efficacy predicted based on the calculation from Colby, indicating that the mixture of streptimidone with malonomicin has a synergistic effect on the control of fungal pathogens. This surprising synergistic effect was observed in tests to control Botrytis cinerea.

2 Fungicidal Activity of a Mixture with Malonomicin in Leaf Disc Assays

### Method:

Streptimidone (CAS: 738-72-7) was purchased from a commercial vendor. A stock solution for streptimidone was produced in DMSO (max. 10 mg/ml). Malonomicin was produced according to Law et al, 2018 (Nature Catalys is |VOL 1|DECEMBER 2018|977-984). A stock solution of malonomicin was produced in water plus 0.025% Tween20.

Assays to test efficacy of mixtures of streptimidone in combination with malonomicin on the control of fungal pathogens in a leaf disc assay were designed for two 24well plates.

Table 5 and table 6: Outline of 24well testplate(1) and testplate(2) including concentration of compounds sprayed per well. The upper number in the cell indicates streptimidone concentration (ppm), the lower number malonomicin concentration (ppm). Column (1) holds a dilution series of streptimidone, row (2-D) holds a dilution series of malonomicin. Well 2-D-(1) represents an untreated check. This design was applied for tests including Puccinia recondita (EPPO code: PUCCRE) with preventive and curative spray timing.

24 well plate (1) ppm

| | (1) | (2) | (3) | (4) | (5) | (6) |
|---|---|---|---|---|---|---|
| 1-A | 200 | 200 | 200 | 200 | 200 | 200 |
| | 0 | 200 | 20 | 6.67 | 2.22 | 0.74 |
| 1-B | 100 | 100 | 100 | 100 | 100 | 100 |
| | 0 | 200 | 20 | 6.67 | 2.22 | 0.74 |
| 1-C | 50 | 50 | 50 | 50 | 50 | 50 |
| | 0 | 200 | 20 | 6.67 | 2.22 | 0.74 |
| 1-D | 25 | 25 | 25 | 25 | 25 | 25 |
| | 0 | 200 | 20 | 6.67 | 2.22 | 0.74 |

24 well plate (2) ppm

| | (1) | (2) | (3) | (4) | (5) | (6) |
|---|---|---|---|---|---|---|
| 2-A | 12.5 | 12.5 | 12.5 | 12.5 | 12.5 | 12.5 |
| | 0 | 200 | 20 | 6.67 | 2.22 | 0.74 |
| 2-B | 6.25 | 6.25 | 6.25 | 6.25 | 6.25 | 6.25 |
| | 0 | 200 | 20 | 6.67 | 2.22 | 0.74 |
| 2-C | 3.13 | 3.13 | 3.13 | 3.13 | 3.13 | 3.13 |
| | 0 | 200 | 20 | 6.67 | 2.22 | 0.74 |
| 2-D | 0 | 0 | 0 | 0 | 0 | 0 |
| | 0 | 200 | 20 | 6.67 | 2.22 | 0.74 |

Table 7: Mixture ratio of compounds sprayed in the 24well plate assay as outlined in table 5 and table 6. The number represents the ratio of compound 1:compound 2. Compound 1 is malonomicin, and compound 2 is streptimidone. The plate design across the two 24well plates spans a wide range from 64:1 up to 1:270.

| | (1) | (2) | (3) | (4) | (5) | (6) |
|---|---|---|---|---|---|---|
| 1-A | | 1:1 | 1:10 | 1:30 | 1:90 | 1:270 |
| 1-B | | 2:1 | 1:5 | 1:15 | 1:45 | 1:135 |
| 1-C | | 4:1 | 1:2.5 | 1:7.5 | 1:23 | 1:68 |
| 1-D | | 8:1 | 1:1.3 | 1:3.7 | 1:11 | 1:34 |
| 2-A | | 16:1 | 1.6:1 | 1:1.9 | 1:5.6 | 1:17 |
| 2-B | | 32:1 | 3.2:1 | 1.1:1 | 1:2.8 | 1:8.4 |
| 2-C | | 64:1 | 6.4:1 | 2.1:1 | 1:1.4 | 1:4.2 |
| 2-D | | | | | | |

A first set of master plates with 1× concentrated spray solution of the streptimidone stock diluted in water with concentrations according to table 5 or table 6, respectively, was prepared. Each well contained 2% DMSO and 0.025% Tween20. Accordingly, a second set of master plates with 1× concentrated malonomicin stock diluted in water was prepared. Each well of the second set contained 0.025% Tween20. Leaf segments placed on agar in 24well plates are sprayed with 8 ul of solution from the master plate containing streptimidone and the leaf segments were let to dry, followed 2 hours later by 8 ul of solution from the master plate containing malonomicin. After second sprays have dried, leaf segments are infected with fungal spores to obtrain a preventive application timing. Alternativeley, leaf segments infected one day before spray of the compounds are used, resulting in a curative spray timing. In addition, several plates were produced where leaf segments were sprayed 2× in absence of test compound (with only DMSO and Tween20), representing the untreated check samples. For each leaf segment percent leaf coverage of disease symptoms was assessed. Percent leaf coverage reduction relative to the untreated check was calculated. Efficacy of the mixtures was tested in duplicate and on different fungal species. Reported efficacy values are the average of two replicate results.

Puccinia recondita (EPPO Code: PUCCRE) with Preventive Spray Timing.

Wheat (cultivar Kanzler) leaf segments are placed on agar in multiwell plates (24-well format) and sprayed with test solutions (8 ul per well). After drying, the leaf disks are inoculated with a spore suspension of the fungus. After appropriate incubation the activity of a compound is assessed 8 dpi (days after inoculation) as preventive fungicidal activity.

Puccinia recondita (EPPO Code: PUCCRE) with Curative Spray Timing.

Wheat (cultivar Kanzler) leaf segments are placed on agar in multiwell plates (24-well format). The leaf disks are then inoculated with a spore suspension of the fungus. One day after inoculation the test solution is sprayed (8 ul per well). After appropriate incubation the activity of a compound is assessed 8 dpi (days after inoculation) as curative fungicidal activity

### Results

Table 8: Control of Puccinia recondita (preventive) for solo compounds and mixtures. The plate design including the concentration of streptimidone and malonomicin are indicated in table 5 and table 6. Values indicate control of fungal growth (% reduction of symptoms on the leaf segment as compared to untreated check).

| | (1) | (2) | (3) | (4) | (5) | (6) |
|---|---|---|---|---|---|---|
| 1-A | 10 | 100 | 100 | 90 | 60 | 35 |
| 1-B | 35 | 100 | 100 | 70 | 45 | 25 |
| 1-C | 0 | 100 | 100 | 80 | 25 | 10 |
| 1-D | 0 | 100 | 80 | 60 | 25 | 0 |
| 2-A | 10 | 100 | 100 | 80 | 35 | 10 |
| 2-B | 0 | 100 | 100 | 90 | 50 | 10 |
| 2-C | 0 | 100 | 100 | 100 | 60 | 0 |
| 2-D | 10 | 100 | 100 | 80 | 10 | 0 |

Table 9: Comparison of measured values for disease control of Puccinia recondita (preventive) (as reported in table 8) with calculated values using the formula from Colby for the same mixture. Numbers reported in the table represent the difference from measured efficacy (in %) minus calculated efficacy (in %). Values around 0 (zero) indicate additive activity, while values above zero suggest synergistic activity.

| | (1) | (2) | (3) | (4) | (5) | (6) |
|---|---|---|---|---|---|---|
| 1-A | | 0 | 0 | 8 | 41 | 25 |
| 1-B | | 0 | 0 | −17 | 4 | −10 |
| 1-C | | 0 | 0 | 0 | 15 | 10 |
| 1-D | | 0 | −20 | −20 | 15 | 0 |
| 2-A | | 0 | 0 | −2 | 16 | 0 |
| 2-B | | 0 | 0 | 10 | 40 | 10 |
| 2-C | | 0 | 0 | 20 | 50 | 0 |
| 2-D | | | | | | |

Table 10: Control of Puccinia recondita (curative) for solo compounds and mixtures. The plate design including the concentration of streptimidone and malonomicin are indicated in table 5 and table 6. Values indicate control of fungal growth (% reduction of symptoms on the leaf segment as compared to untreated check).

| | (1) | (2) | (3) | (4) | (5) | (6) |
|---|---|---|---|---|---|---|
| 1-A | 20 | 100 | 100 | 100 | 90 | 70 |
| 1-B | 20 | 100 | 100 | 100 | 95 | 35 |
| 1-C | 25 | 100 | 100 | 100 | 90 | 35 |
| 1-D | 35 | 100 | 100 | 100 | 90 | 25 |
| 2-A | 0 | 100 | 100 | 100 | 80 | 35 |
| 2-B | 0 | 100 | 100 | 100 | 90 | 60 |
| 2-C | 0 | 100 | 100 | 100 | 95 | 35 |
| 2-D | 10 | 100 | 100 | 100 | 70 | 35 |

Table 11: Comparison of measured values for disease control of Puccinia recondita (curative) (as reported in table 10) with calculated values using the formula from Colby for the same mixture. Numbers reported in the table represent the difference from measured efficacy (in %) minus calculated efficacy (in %). Values around 0 (zero) indicate additive activity, while values above zero suggest synergistic activity.

| | (1) | (2) | (3) | (4) | (5) | (6) |
|---|---|---|---|---|---|---|
| 1-A | | 0 | 0 | 0 | 14 | 22 |
| 1-B | | 0 | 0 | 0 | 19 | −13 |
| 1-C | | 0 | 0 | 0 | 12.5 | −16 |
| 1-D | | 0 | 0 | 0 | 9.5 | −33 |
| 2-A | | 0 | 0 | 0 | 10 | 0 |
| 2-B | | 0 | 0 | 0 | 20 | 25 |
| 2-C | | 0 | 0 | 0 | 25 | 0 |
| 2-D | | | | | | |

### Conclusions:

Streptimidone and malonomicin can be mixed to obtain full or partial control of fungal pathogens. The mixture ratio of the two compounds can vary greatly in mixtures and still produce 50% or more control of the fungal growth when sprayed on a leaf. Surprisingly, the efficacy of many mixtures is better than the efficacy predicted based on the calculation from Colby, indicating that the mixture of streptimidone with malonomicin has a synergistic effect on the control of fungal pathogens when sprayed on a leaf. This surprising synergistic effect was observed in tests to control Puccinia recondita.

1. A composition comprising streptimidone and malonomicin.

2. A composition as claimed in claim 1 in which the ratio of streptimidone to malonomicin is 10:1 to 1:500 by weight.

3. A composition as claimed in claim 2 in which the ratio of streptimidone to malonomicin is 1:1 to 1:300 by weight.

4. An agrochemical composition comprising a fungicidally effective amount of a mixture comprising streptimidone and malonomicin.

5. The agrochemical composition according to claim 4 which further comprises an agrochemically-acceptable diluent or carrier.

6. The agrochemical composition according to claim 4, comprising the composition thereof.

7. A method of controlling or preventing infestation of plants by fungi, wherein a fungicidally effective amount of the composition of claim 1, is applied to the plants, to parts thereof or the locus thereof.

8. A method as claimed in claim 7 in which the composition is applied to plants at a rate of from 0.1 g to 6 kg of the combined weight of streptimidone and malonomicin per hectare.

9. A method as claimed in claim 7 in which the composition is applied to seeds at a rate of 0.001 to 100 g of the combined weight of streptimidone and malonomicin per kg of seed.

10. The method according to claim 7 in which the plants are selected from the group consisting of cereals and pulses.

11. The method according to claim 7 in which the the fungi are selected from the group consisting of Fusarium avenaceum, Fusarium culmorum, Fusarium langsethiae, Fusarium poae, Fusarium sporotrichioides, Fusarium tricinctum, Fusarium virguliforme, Fusarium verticillioides, Fusarium subglutinans Zymoseptoria tritici, Puccinia triticina (=P. recondita), Mycosphaerella fijiensis, Puccinia striiformis, Magnaporthe grisea and Rhizoctonia solani.

12. Use of a composition comprising streptimidone and malonomicin according to claim 1 as an anti-fungal agent or as a fungicide.
